(19) United States
(12) Patent Application Publication
(10) Pub. No.: US 2008/0281606 A1
(43) Pub. Date: Nov. 13, 2008

(54) IDENTIFYING AUTOMATED CLICK FRAUD PROGRAMS

(75) Inventors: Brendan J. Kitts, Seattle, WA (US); Tarek Najm, Kirkland, WA (US); Brian Burdick, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/745,264

(22) Filed: May 7, 2007

(51) Int. Cl. G06Q 99/00

(52) U.S. Cl. 705/1

(57) ABSTRACT

Methods and systems for identifying automated click fraud programs are provided. Upon receiving a request for presentation of a web page, the probability that the user is robotic is determined. The determined probability, along with historic behavior, if available, related to the requesting user, is used to determine a score that may be utilized to select advertisements for presentation to the user. If the score indicates a high likelihood that the user is robotic, an advertisement designed to solicit user behavior known to be associated with robots may be selected to confirm the suspicion. Alternatively, if the likelihood that the user is robotic is high enough, advertisement presentation may be largely suppressed. If, on the other hand, the score indicates a high likelihood that the user is human, a standard advertisement and/or an advertisement designed to solicit user feedback related to advertisements and/or publishers may be selected.

### BACKGROUND

Ad-serving companies, e.g., Microsoft®, need to serve advertisements to users that visit particular web sites. Typically, the ad-serving company bills an advertiser for legitimate responses, e.g., clicks or actions, from interested users. Unfortunately, advertisers, publishers, and users may abuse this system for their own financial gain.

Advertisers may generate vast numbers of advertisements that are irrelevant to the web sites being visited by the users. Because it is inexpensive to “mass market” rather than carefully target customers, this behavior benefits the advertisers that engage in offering irrelevant advertisements. Although this is not necessarily malicious, this behavior degrades the overall relevance of the advertisements served by the ad-serving company and adversely affects the likelihood that publishers will be interested in these advertisements. Accordingly, it is beneficial to identify and discourage irrelevant advertising.

Publishers may create a web site and indicate display categories that are irrelevant when compared to the web site. In addition, publishers may select keywords as being associated with their web sites so as to attract high value advertisements, e.g., utilizing terms like “mesothelioma” with a $100 cost-per-click (CPC), even though the topic of the web site is not related to the selected keyword. Further, the publisher may engage in “click fraud,” where the publisher itself clicks on advertisements being displayed at the publisher's web site, thus, causing false charges to the advertisers.

Users, often when affiliated with an advertiser or publisher, may also engage in click fraud, i.e., responding to advertisements without any interest therein. As such, the advertiser is billed for clicks or actions that do not relate to interest in the material within the advertisement being served by the ad-serving companies.

This malicious, and even illegal, behavior of advertisers, publishers, and users may be automated through the employment of robotic users, e.g., robots. Due to the complex and variable design of robotic users, ad networks have difficulty distinguishing between the requests and responses from robotic users and those from human users, and consequently, accurately detecting the inappropriate behavior. Because many ad-serving companies utilize a pricing scheme that charges the advertiser per action or click-through, (e.g., charge-per-click (CPC) or charge-per-action (CPA) pricing models), and because actions and click-through may be automated by the robotic users, the advertiser's budget may be prematurely expended without the intended sales while the publisher's revenue is artificially increased. Robotic users may also drain the advertiser's computing bandwidth and/or deplete revenue received by the publisher. Accordingly these robotic users accelerate online detrimental behavior and inaccurate advertising charges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to computerized methods and systems for identifying automated click fraud programs. Upon receiving a request for presentation of a web page, the probability that the user is robotic vs. human is determined, at least in part, based upon the nature of the request. The determined probability, along with historic behavior related to the requesting user, if available, is used to determine a score that may be utilized to select advertisements for presentation to the user. If the score indicates a high likelihood that the user is robotic, an advertisement designed to solicit user behavior known to be associated with robots may be selected to confirm the suspicion. Alternatively, if the likelihood that the user is robotic is high enough, advertisement presentation may be largely suppressed. If, on the other hand, the score indicates a high likelihood that the user is human, a standard advertisement and/or an advertisement designed to solicit user feedback related to advertisements and/or publishers may be selected. The user behavior related to a trap or feedback advertisement, probability and/or score are stored in association with a user identifier and may be utilized to train the system for future scoring, if desired.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system configured to select advertisements for presentation based upon at least one measured user behavior, in accordance with an embodiment of the present invention;

FIG. 3 is a flow diagram showing a method for selecting advertisements for presentation based upon at least one user request for a web page, in accordance with an embodiment of the present invention;

FIG. 4 is a flow diagram showing a method for utilizing an unapparent advertisement to solicit a web page request, in accordance with an embodiment of the present invention;

FIG. 5 is a flow diagram showing a method for comparing selection coordinates based on a request associated with an image advertisement, in accordance with an embodiment of the present invention;

FIG. 6 is a flow diagram showing a method for presenting a feedback advertisement, in accordance with an embodiment of the present invention;

FIG. 7 is a flow diagram showing a method for training a scoring module and receiving a score therefrom, in accordance with an embodiment of the present invention;

FIG. 8 is a flow diagram showing a method for providing and/or adjusting a rate of advertisement presentation, in accordance with an embodiment of the present invention;

FIG. 9 is a flow diagram showing a method for presenting an advertisement and/or a virus warning, in accordance with an embodiment of the present invention;

FIG. 10 is an illustrative screen display of an exemplary user interface for displaying trap ads, in accordance with an embodiment of the present invention;

FIG. 11 is an illustrative screen display of an exemplary user interface for displaying a feedback advertisement prompt, in accordance with an embodiment of the present invention;

FIG. 12 is an illustrative screen display of an exemplary user interface for displaying a survey portion of the feedback advertisement prompt, in accordance with an embodiment of the present invention;

FIG. 13 is an illustrative screen display of an exemplary user interface for displaying an antivirus warning, in accordance with an embodiment of the present invention;

FIG. 14 is an illustrative screen display similar to the exemplary user interface of FIG. 13, but instead displaying the antivirus warning as an advertisement, in accordance with an embodiment of the present invention; and

FIG. 15 is an illustrative screen display similar to the exemplary user interface of FIG. 14, but further displaying the a link to the advertiser's web page, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems, and computer-readable media having computer-executable instructions embodied thereon, for presenting advertisements designed to aid in differentiating human from robotic users. As utilized herein, the term “advertisement” is not meant to be limiting. Further, the term “advertisement” could be, or include, a promotional communication between a seller offering goods or services and a prospective purchaser (e.g., a human user) of such goods or services; or a noncommercial communication presented by a publisher on its own web page, e.g., a trap advertisement, a virus warning, or the like. In addition, an advertisement may contain any type or amount of data that is capable of being communicated for the purpose of generating interest in and/or sale of goods or services, e.g., text animation, executable information, video, audio, and other various forms known to those of ordinary skill in the art.

“Presentation,” as contemplated by one aspect of the present invention, includes display in association with a user interface. As utilized herein, the term “user interface” may include an aggregate of means by which users interact with a particular machine, device, computer program or other complex tool (e.g., computing system). The user interface provides means of both input, allowing the users to manipulate a computing system (e.g., inputting a request or communicating a click-through), and output, allowing the computing system to produce the effects of the users' manipulation (e.g., presenting advertisements).

Embodiments of the present invention relate to computerized methods and systems for selecting one or more advertisements for presentation based upon at least one request for a web page submitted by a user. In embodiments, the web page request may be received in association with the presentation of a trap advertisement (e.g., an unapparent advertisement or an image advertisement) or in association with the presentation of a feedback advertisement designed to solicit advertisement and/or publisher feedback from human users. The nature of the request, as more fully described below, is utilized to determine a probability that the requesting user is robotic as opposed to human. This determined probability, along with historic behavior related to the requesting user, is used to provide a score that is subsequently utilized in selecting one or more advertisements for presentation to the user. In one embodiment, if the score overcomes a threshold pre-defined based on robotic traffic patterns, a virus cleaner advertisement is presented to warn a potential human user of suspected infection and/or provide a mechanism for cleaning their system of viruses. In another embodiment, the score is utilized to adjust the rate at which commercial advertisements, as opposed to trap advertisements, are presented, thereby optimizing web page publisher revenue and reducing inappropriate billing for invalid requests.

Accordingly, in one aspect, the present invention provides one or more computer-readable media having computer-executable instructions embodied thereon that, when executed, perform a method for identifying automated click fraud programs. The method includes presenting an advertisement to a user, the user being associated with an identifier; measuring at least one user behavior related to the presented advertisement; utilizing the measured at least one user behavior to determine a probability that the user is robotic; and storing the probability and the associated at least one user behavior in association with the user identifier.

In another aspect of the present invention, a computer system is provided for identifying automated click fraud programs. The computer system includes a probability determining module configured to determine a probability that a user submitting a request for a web page is a robotic user based upon at least one measured user behavior; a scoring module configured to analyze at least one of the probability that the user submitting the request for the web page is a robotic user and historic user behavior and to assign a score to the user; an advertisement selection module configured to utilized the assigned user score to select one or more advertisements for presentation; and an historic user behavior database configured to store one or more of the determined probability, the at least one measured user behavior, the assigned score and the one or more selected advertisements in association therewith.

In another aspect, the present invention provides a computerized method for selecting one or more advertisements for presentation that are designed to warn a user of a potential virus. The method includes, incident to receiving at least one user request for a web page, determining a probability that the at least one request originated from a robotic user and utilizing the determined probability to assist in selecting the one or more advertisements to present. If the determined probability is high, the one or more selected advertisements include at least one virus warning.

Having briefly described an overview of embodiments of the present invention, an exemplary operating environment suitable for use in implementing embodiments of the present invention is described below.

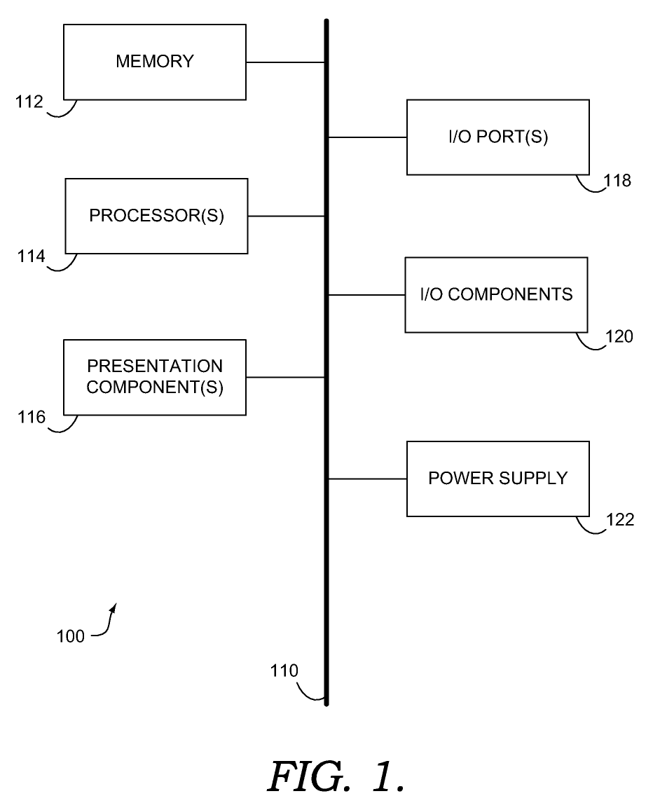

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

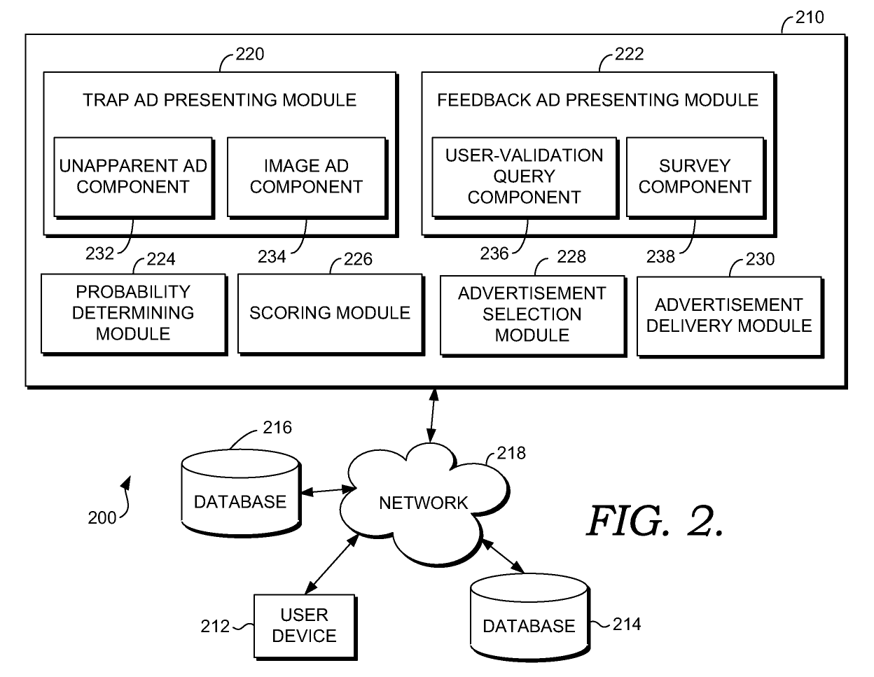

Turning now to FIG. 2, a block diagram is illustrated that shows an exemplary computing system 200 configured to select advertisements for presentation based upon at least one measured user behavior, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated therein.

Computing system 200 includes an advertisement delivery engine 210, a user device 212, an advertisement database 214, and a historic user behavior database 216 all in communication with one another via a network 218. The network 218 may include, without limitation, one or more local area networks (LANs) and/or wide area networks (WANs). Such networking environments are commonplace in offices, enterprise-wide computer networks, intranets, and the Internet. Accordingly, the network 218 is not further described herein.

The advertisement database 214 may be configured to store information associated with various types of advertisements, as more fully discussed below. In various embodiments, such information may include, without limitation, one or more unapparent advertisements, one or more image advertisements, one or more virus cleaning/warning advertisements, one or more user feedback advertisements, advertiser and/or publisher identities and the like. In addition, the advertisement database 214 may include zero advertisements stored in association therewith but rather contain an organizational blueprint with an empty set. In some embodiments, the advertisement database 214 is configured to be searchable for one or more advertisements to be selected for presentation, as more fully described below.

It will be understood and appreciated by those of ordinary skill in the art that the information stored in the advertisement database 214 may be configurable and may include any information relevant to an advertisement. Further, though illustrated as a single, independent component, database 214 may, in fact, be a plurality of databases, for instance, a database cluster, portions of which may reside on a computing device associated with the advertisement delivery engine 210, the user device 212, another external computing device (not shown), and/or any combination thereof.

The historic user behavior database 216 may be configured to store information associated with a plurality of system users and their associated user behaviors, as more fully discussed below. In various embodiments, such information may include, without limitation, one or more user identities, one or more probabilities related to a user, one or more scores assigned to a user, and the like. In addition, the historic user behavior database 216 may include no actual user behavior information stored in association therewith but rather contain an organizational blueprint with an empty set. In some embodiments, the historic user behavior database 216 is configured to be searchable for one or more user identities based upon, for instance, an IP address or the like, and associated information, as more fully described below.

It will be understood and appreciated by those of ordinary skill in the art that the information stored in the historic user behavior database 216 may be configurable and may include any information relevant to a user and their associated user behavior. Further, though illustrated as a single, independent component, database 216 may, in fact, be a plurality of databases, for instance, a database cluster, portions of which may reside on a computing device associated with the advertisement delivery engine 210, the user device 212, another external computing device (not shown), and/or any combination thereof.

Each of the advertisement delivery engine 210 and the user device 212 shown in FIG. 2 may be any type of computing device, such as, for example, computing device 100 described above with reference to FIG. 1. By way of example only and not limitation, the advertisement delivery engine 210 and/or the user device 212 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of embodiments hereof.

As shown in FIG. 2, the advertisement delivery engine 210 includes a trap advertisement presenting module 220, a feedback advertisement presenting module 222, a probability determining module 224, a scoring module 226, an advertisement selection module 228, and an advertisement delivery module 230. In some embodiments, one or more of the modules 220, 222, 224, 226, 228, and 230 may be implemented as stand-alone applications. In other embodiments, one or more of the modules 220, 222, 224, 226, 228, and 230 may be integrated directly into the operating system of the advertisement delivery engine 210 or the user device 212. By way of example only, the advertisement selection module 228 may be housed in association with the advertisement database 214, while the scoring module 226 may reside in a server (not shown). In the instance of multiple servers, the present invention contemplates providing a load balancer to federate incoming queries to the servers. It will be understood by those of ordinary skill in the art that the modules 220, 222, 224, 226, 228, and 230 illustrated in FIG. 2 are exemplary in nature and in number and should not be construed as limiting. Any number of modules may be employed to achieve the desired functionality within the scope of embodiments of the present invention.

The trap advertisement presenting module 220 is configured to provide, incident on receiving at least one request associated therewith, user indicia pertaining to a robotic user. By way of example, the request may be received at a user interface as the result of user input. It will be understood and appreciated by those of ordinary skill in the art that multiple methods exist by which a user may input a request. For instance, requests may be input, by way of example only, utilizing a keyboard, joystick, trackball, touch-advertisement, or the like. Alternative user interfaces known in the software industry are contemplated by the invention. The at least one request is typically a user-initiated action or response that is received at a user interface, as discussed above. Examples of a request are a click, click-through, or selection by a user, e.g., human user or robotic user; however, it is understood and appreciated by one of ordinary skill in the art that a request may take any number of forms of indication at a web page. Further, it is contemplated by the present invention that a robotic user may be any non-human operator (i.e., an internet bot, web bot program, virus, robot, web crawler, web spidering program, or any software applications that run automated tasks over the Internet), which is an artificial agent that, by its actions, conveys a sense that it has intent or agency of its own. Even further, a human user is contemplated as being a human, but also, an entity (virtual or physical) acting under the present intent of a human operator.

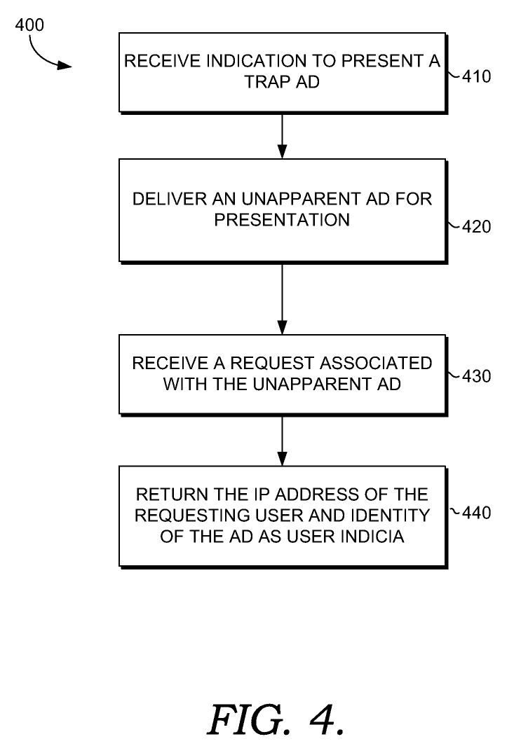

The trap advertisement presentation module 220 includes an unapparent advertisement (or honey pot advertisement) component 232 and an image advertisement component 234. The unapparent trap advertisement component 232 is configured to present one or more advertisements that may trigger at least one request from a robotic user, as more fully discussed below with reference to FIG. 4. In one embodiment, the unapparent advertisement is designed to resemble an advertisement when approached by a robotic user, e.g., having a link to another web page, such that the robotic user automatically executes a request in association with unapparent advertisement similar to requests made in association with other advertisements. In addition, upon presentation of the unapparent advertisement, the unapparent advertisement is not readily identifiable by a human user. That is, the unapparent advertisement is designed such that it is not distinguishable as a separate advertisement to a human user when examined in the context of the user interface.

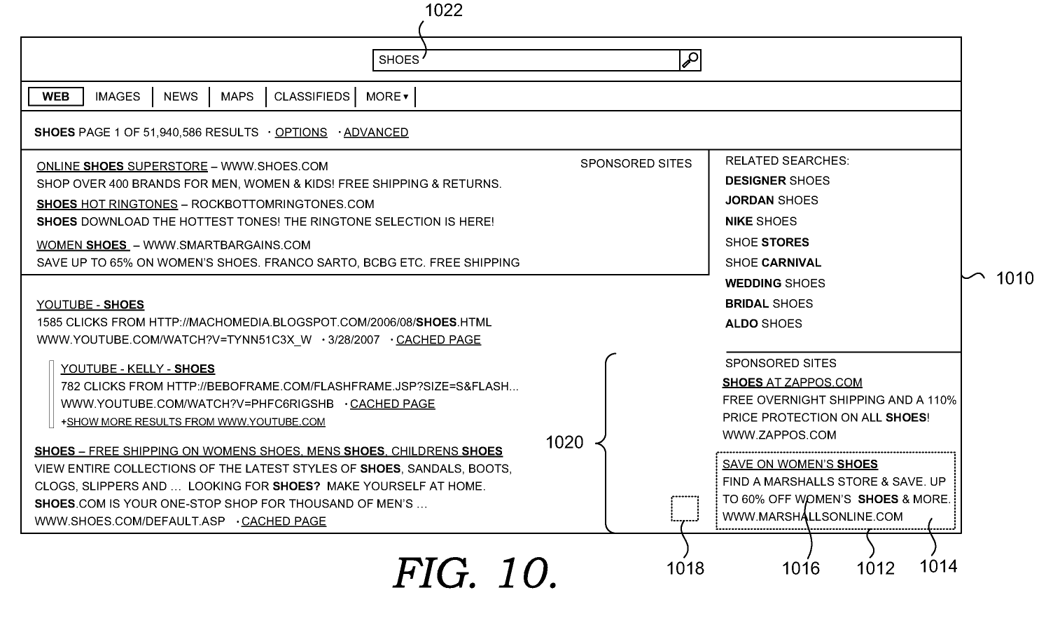

By way of example only, the unapparent advertisement may be an “<A HREF>,” a 1×1 pixel, or an alphanumeric character of the same color as the background of a web page, yet having the same linking structure as other advertisements on the web page, more fully discussed below with reference to FIG. 10 at numeral 1005. When presented with this unapparent advertisement, a human user will likely not recognize it as a link, and accordingly, will not submit a request in association therewith. However, a robotic user (e.g., spider, crawler, and other software programmed to submit a request at each link), when presented with this unapparent advertisement will likely submit a request.

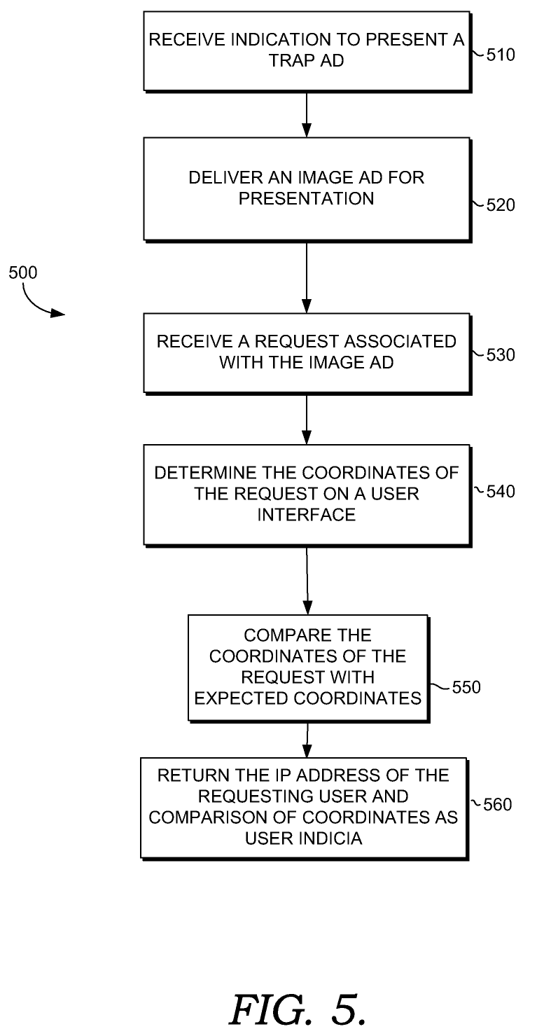

The image advertisement component 234 is configured to solicit at least one request, wherein the coordinates of the at least one request on a user interface are determined, as more fully described below with reference to FIG. 5. Determining the coordinates of a request associated with an advertisement is a valuable method for distinguishing whether the request is provided by a robotic user or human user. One embodiment of determining the coordinates of a request includes measuring the position of a click on a user interface display.

Upon determination of the coordinates of a request, the image advertisement component 234 may compare those coordinates with expected coordinates, e.g., coordinates of the “call-to-action” of the image advertisement, more fully discussed below with reference to FIG. 10 at numeral 1002. In one embodiment, the expected coordinates relate to the position of a click that a human user will likely submit at a user interface display. On the other hand, a robotic user typically will submit a click at a random place in association with the image advertisement on the user interface display. As such, the comparison may provide an accurate indication of whether a robotic user or human user has provided the request. Typically, incident upon making the comparison, it is returned from the image advertisement component 234 to the probability determining module 224 as user indicia, wherein user indicia may further include the IP address of the requesting user. Returning may comprise, in an exemplary embodiment, embedding the coordinates of the request in the query stream.

Although two different configurations of trap advertisements have been shown, it should be understood and appreciated by those of ordinary skill in the art that other trap advertisements or robotic user identification components could be used, and that the invention is not limited to those embodiments shown and described.

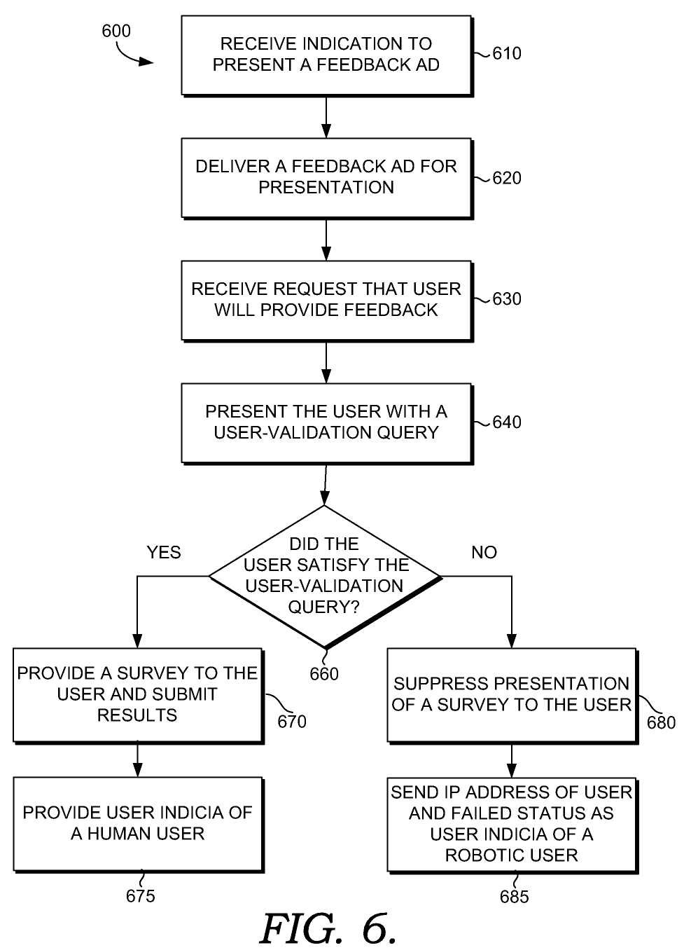

The feedback advertisement presentation module 222 is configured to present a feedback advertisement, wherein the feedback advertisement comprises noncommercial content that is accessible by satisfying a user-validation query, as more fully discussed below with reference to FIGS. 6, 11, and 12. Typically, the feedback advertisement may be accessed by both human and robotic users, thus, returning inaccurate information. However, the present invention addresses this issue by providing a user-validation query in order to validate that the feedback is generated by a human user, as discussed below.

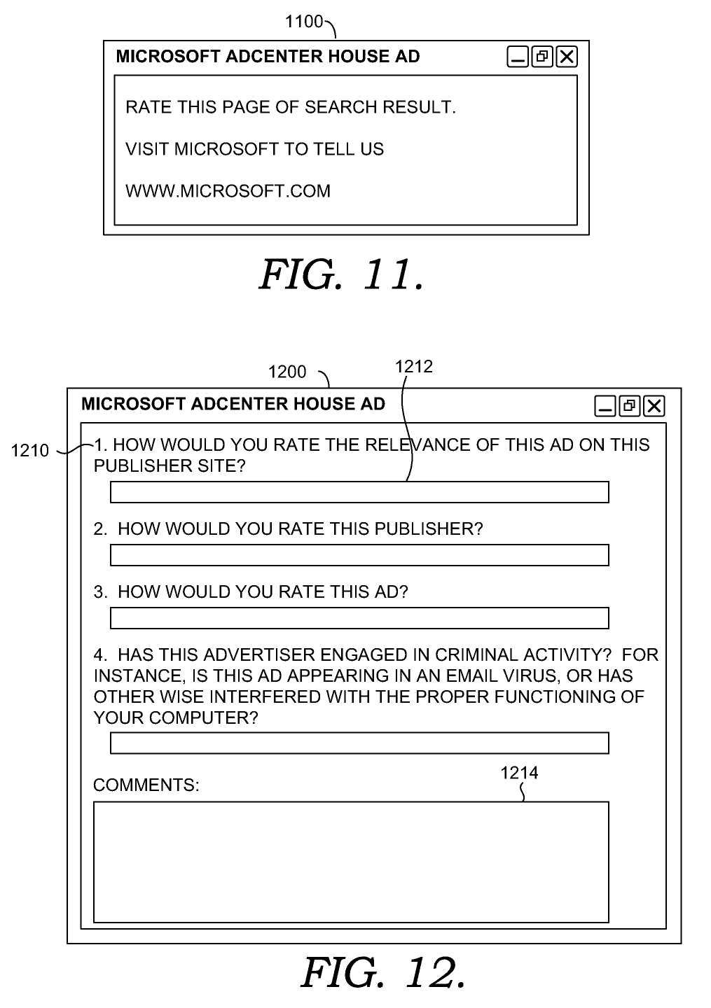

In the illustrated embodiment, the feedback advertisement includes a user-validation query component 236 and a survey component 238. The user-validation query component 236 is configured to provide a user-validation query upon selection of a feedback advertisement prompt (FIG. 11), wherein user indicia is returned upon determining whether the user-validation query is satisfied. In one embodiment, the user-validation query is a Turing test, wherein a distorted alphanumeric string and text entry area are presented such that the distorted alphanumeric string must be transcribed therein. In another embodiment, a passport login may be required, wherein input of a successful login by the requesting user satisfies this style of user-validation query. Although two embodiments are described, the present invention contemplates any test, query, or user interface that is helpful in distinguishing between a human user and robotic user as being an acceptable configuration of the user-validation query.

If the user-validation query is satisfied, a survey may be presented, e.g., utilizing the survey component 238. Alternatively, if the survey is not satisfied, then the survey is not presented. However, in either of these instances, the IP address of the user and status of whether the user-validation query is satisfied is sent as user indicia of a human user or robotic user to the probability determining module 224. Accordingly, the user indicia generated from the user-validation query component 238 is useful to help provide examples of requests that are likely from a human user or robotic user.

The survey component 238 is configured to present noncommercial content, e.g., a survey. In other embodiments, the noncommercial content may be comprise a solicitation of relevance of the at least one advertisement, quality of a publisher, and relevance of at least one advertisement with regard to and advertiser, as more fully described with reference to FIG. 12. As discussed above with reference to the user-validation query component 236, because the survey component 238 is presented to the user upon satisfying the user-validation query, there is a high probability that the results submitted from the survey are from a human user, and thus, useful feedback.

Useful feedback from the large, engaged, and interested audience of human users may provide a variety of input to a web page publisher. In one instance, the survey may assist in judging the relevance of an advertisement. Here, the human users have an opportunity to comment on advertisements that may be irrelevant, untargeted, selling illegal schemes (e.g., porn, hate, money-making), or any other advertisement where the content is questionable. In another instance, the survey may help gather feedback on the relevance and quality of the web page publisher. Here, human users have an opportunity to report publishers that purvey illegal schemes, as discussed above, or that simply provide a poor user experience upon entering that particular web page. In yet another instance, the survey asks for ratings on the quality and relevance of the advertisement with regards to publisher, e.g., effectiveness of the ad-matching algorithm. Although several instances of survey material are discussed above, other fields of useful feedback are apparent to those of ordinary skill in the art to which the present invention pertains. Examples of questions that achieve the ends discussed above are provided at FIG. 12. In one instance, if the human user satisfactorily completes the survey, s/he is presented with a prize or reward; however, it is contemplated that in this instance a cookie is placed on the human user's device, or the human user's IP address noted, such that multiple prizes are not awarded. Next, the survey results are returned to the interested party, e.g., web page to the publisher or advertiser.

Incident to receiving a request for a web page originating from a presented advertisement, the probability determining module 224 is configured to determine a probability that a user submitting the web page request is a robotic user based upon at least one measured user behavior. More specifically, information related to the advertisement associated with the request (and possibly the requesting user's IP address) is utilized in determining whether it was a human user or robotic user that provided the request. In one exemplary embodiment, if the request is associated with an unapparent advertisement, then a determination of high probability that the request originated from a robotic user is likely. In another exemplary embodiment, if the request is associated with an image advertisement and the coordinates of a request and the coordinates of an expected request are dissimilar upon comparison, then a determination of high probability that the request originated from a robotic user is likely. However, in yet another embodiment, if the request is associated with a feedback advertisement and the user-validation query is satisfied, then a determination of low probability that the request originated from a robotic user is likely. Incident to a determination of a probability that the requesting user is a robotic user, the determination is forwarded to the scoring module 226.

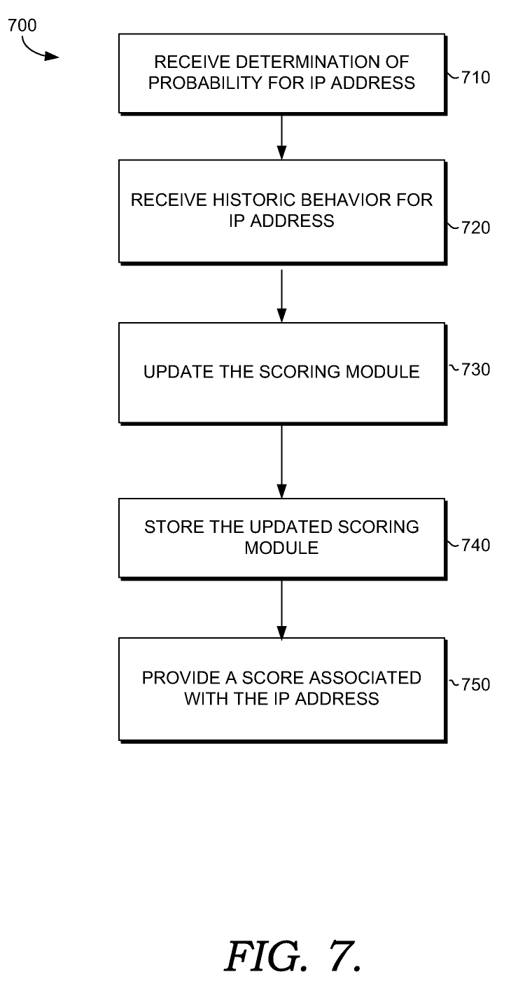

The scoring module 226 is configured to analyze at least one of the probability that the user submitting the request for the web page is a robotic user and historic user behavior and to assign a score to the user, as more fully discussed below with reference to FIG. 7. Providing the score is a flexible operation that involves comparing external information, e.g., information associated with the request (user indicia received from the probability determining module 224), and internal information within the scoring module 226. In one embodiment, the score is based on internally retrieved information that is related to the IP address associated with the request. In another embodiment, previously collected statistical information stored in the scoring module 226, e.g., click-stream traffic patterns, is accessed and compared to the historical behavior of the IP address (e.g., accessed from the historic user behavior database 216). In yet another embodiment where no IP address is available, the determination of a probability that the request originated from a robotic user is analyzed and adjusted. Accordingly, the score may represent a more accurate probability that the request originated from a robotic user because more information for analysis is available at the scoring module 226.

In embodiments, the scoring module 226 is further configured to be trained. Training is comprised of receiving information, examining that information in view of click-stream traffic patterns already stored in association with the scoring module 226 (and/or accessible from historic user behavior database 216), and updating the stored information such that the scoring module 226 is better able to distinguish a human user from a robotic user upon receiving future requests. Receiving information includes receiving the determination of probability of the request originating from a robotic user and the requesting user's IP address from probability determining module 224. If an IP address is received, the scoring module 226 may additionally request any historic behavior related to that IP address, for instance, from historic user behavior database 216. Examining the information includes to comparing the historic behavior against known or previously collected, click-stream traffic patterns of a robotic user, a human user, or both. By way of example only, comparison comprises analyzing click-through rate or conversion statistics that are robotic in nature in view of historical behavior associated with user indicia of a robotic user. Updating, with reference to the previous example, includes incorporating any differences between the historical behavior of an identified robot and known robotic click-stream traffic patterns into the scoring module 226 and storing the comparison as an update therein.

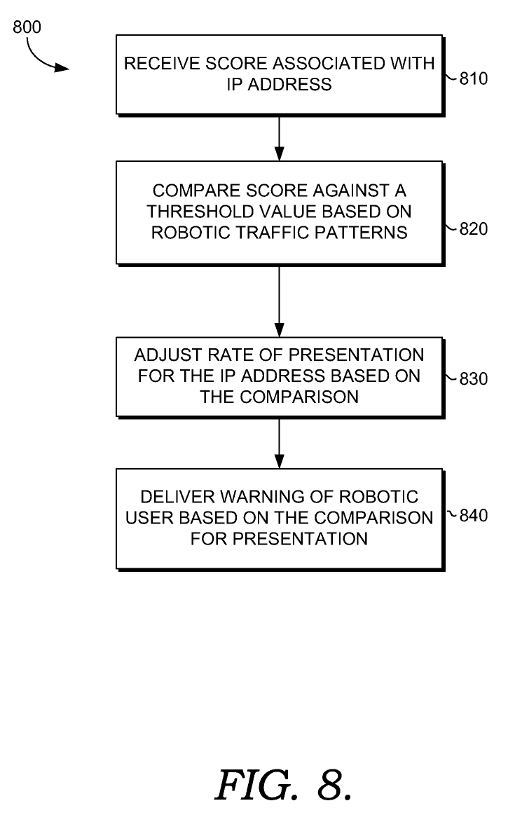

The advertisement selection module 228 is configured to utilize the assigned user score to select one or more advertisements for presentation, as more fully discussed below with reference to FIG. 8. In one embodiment, the score is compared against a threshold value, wherein the threshold value pertains to robotic traffic patterns, as more fully discussed below.

As can be understood and appreciated by those of ordinary skill in the art, the advantage of selection is that it can serve a variety of purposes. For instance, if the score overcomes the threshold value, then it is likely that the request originated from a human user, and correspondingly, a commerical advertisement is selected for presentation. Further, the rate of presentation (i.e., the frequency at which non-commercial, or trap, advertisements are presented in context to the commercial advertisements) may be adjusted for that particular requesting user. As such, revenue is optimized for the web page publisher by reducing the rate of presenting non-commercial advertisements. If the score does not overcome the threshold value, then it is likely that the request originated from a robotic user, and correspondingly, the commercial advertisements are withheld by adjusting the rate of presentation. Accordingly, inappropriate advertiser billing is reduced. It will be understood and appreciated by those of ordinary skill in the art that methods for selecting the rate of presentation and the type of advertisements associated therewith are not limited to the embodiments described herein and that the nature the threshold value may vary accordingly.

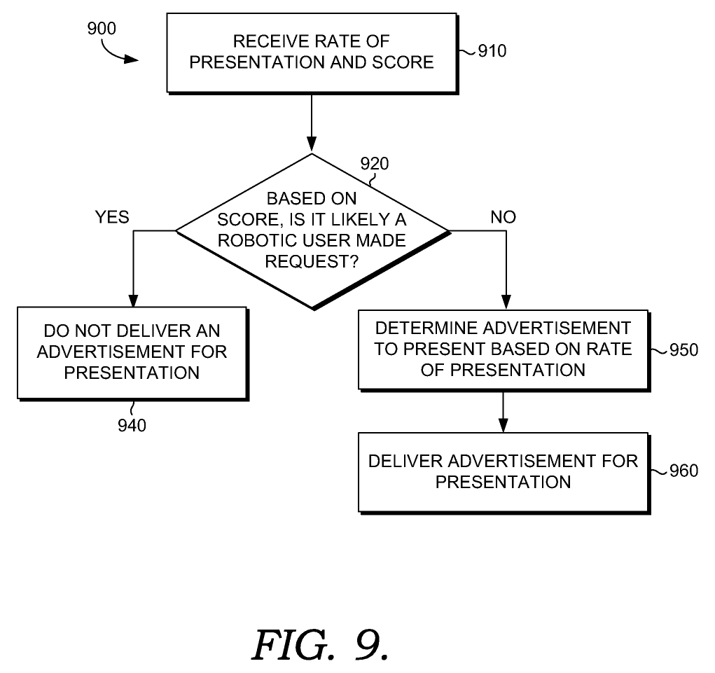

The advertisement delivery module 230 is configured to delivery one or more advertisements to the user device 212 for presentation, for instance, at a user interface associated therewith, as more fully discussed below with reference to FIG. 9. Presenting advertisements is based on a variety of considerations. In some instances, the considerations comprise the rate of presentation offered by the advertisement selection module 228, the score offered by the scoring module 226, or both. In one embodiment, the score may be used to suppress presentation of any advertisement. If it is determined, by way of any consideration, that an advertisement is to be displayed, then the advertisement delivery module 230 may serve the appropriate advertisement(s) to the user device 212.

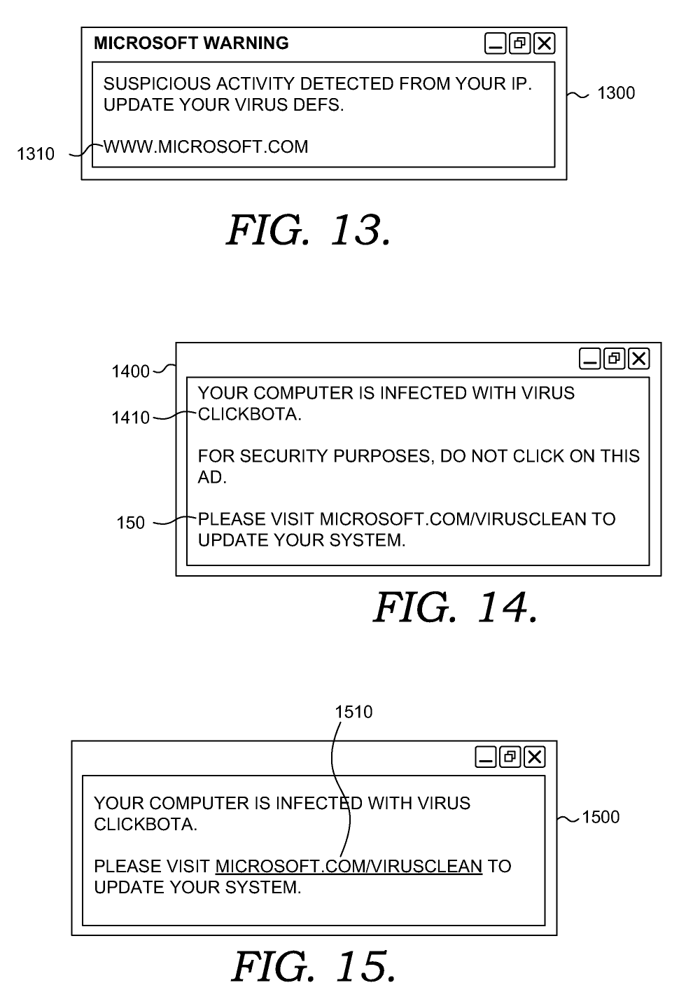

As discussed above, the type of advertisement may be commercial (e.g., provided by an advertiser), non-commercial (e.g., feedback advertisement provided by a web page publisher), or a warning of robotic user. The warning of robotic user is typically presented to a suspected human user's device that has indicated a robotic user originated a request therefrom. That is, based on the adjusted rate of presentation, the advertisement delivery module 230 may present a warning upon noticing that the more recent requests are of a robotic nature as opposed to historic behavior indicating a human user, e.g., IP address. Embodiments of the warning include virus cleaning advertisements and are discussed in more detail below with reference to FIGS. 13-15. It will be understood and appreciated by those of ordinary skill in the art that methods for selecting advertisements for presentation to a user are not limited to the embodiments described herein, and that considerations and the application thereof may vary accordingly.

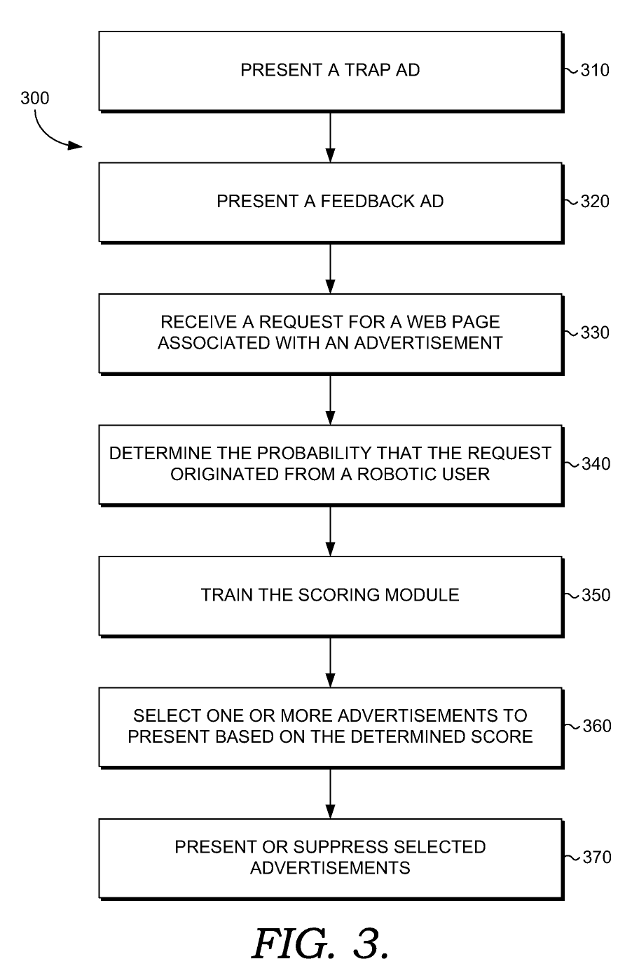

Turning now to FIG. 3, a flow diagram is illustrated that shows a method 300 for selecting for presentation one or more advertisements based upon at least one request for a web page, in accordance with an embodiment of the present invention. Initially, as indicated at blocks 310 and 320, a trap advertisement is presented, e.g., utilizing trap advertisement presenting module 220, and a feedback advertisement is presented, e.g., utilizing feedback advertisement presenting module 222. (It will be understood and appreciated by those of ordinary skill in the art that presentation of both a trap advertisement and a feedback advertisement is exemplary only and that embodiments having only one type of advertisement are contemplated to be within the scope of the present invention.) Next, a request is received from a web page, the request being associated with an advertisement that may be one of the trap advertisement or the feedback advertisement or may be another advertisement presented in association with the web page. This is indicated at block 330. Subsequently, based upon the nature of the request, the probability that the request originated from a robotic user is determined, e.g., utilizing the probability determining module 224, as indicated at block 350. Subsequently, or concomitantly therewith, as indicated at blocks 350 and 360, the scoring module is trained, e.g., utilizing scoring module 226, and one or more advertisements are selected for display based upon input received from the trained scoring module 226, e.g., utilizing advertisement selection module 228. The one or more advertisements are then delivered to a computing device associated with the user, e.g., utilizing delivery module 230, or suppressed. This is indicated at block 370.

With reference to FIG. 4, a flow diagram is illustrated that shows a method 400 for utilizing an unapparent advertisement to solicit a request, in accordance with an embodiment of the present invention. Initially, an indication to present a trap advertisement is received, e.g., utilizing the rate of presentation from advertisement selection module 228, as indicated at block 410. As indicated at block 420, an unapparent advertisement is subsequently delivered for presentation in association with the user's computing device, e.g., utilizing advertisement delivery module 230. As indicated at blocks 430 and 440, if a request associated with the unapparent advertisement is received, then the IP address of the requesting user and user indicia relating to the trap advertisement is returned, e.g., utilizing unapparent advertisement component 232.

As shown in FIG. 5, a flow diagram is illustrated that depicts a method 500 for comparing coordinates based on a request associated with an image advertisement, in accordance with an embodiment of the present invention. Similar to the discussion above with reference to FIG. 4, an indication to present a trap advertisement is received, e.g., utilizing the rate of presentation from advertisement selection module 228, as indicated at block 510. As indicated at block 520, the image advertisement is delivered for presentation in association with the user's computing device, e.g., utilizing advertisement delivery module 230. However, as indicated at blocks 530 and 540, if a request associated with the image advertisement is received, then the coordinates of the request on the user interface are determined, e.g., utilizing image advertisement component 234. These coordinates may then be compared with the expected coordinates, as indicated at block 550, and the comparison of coordinates may be provided as user indicia of the requesting user. This is indicated at block 560.

Turning now to FIG. 6, a flow diagram is illustrated that shows a method 600 for presenting a feedback advertisement and receiving a survey in response thereto, e.g., utilizing feedback advertisement presenting module 222, in accordance with an embodiment of the present invention. Initially, as depicted at block 610, an indication to receive a feedback advertisement is received, e.g., utilizing advertisement selection module 228. Typically, the advertisement delivery module 230 will then deliver a feedback advertisement for presentation in association with a user interface associated with the user's computing device, as indicated at block 620. In one embodiment, a request to provide feedback is received from a user in response to a feedback advertisement prompt, e.g., as depicted in FIG. 11. This is indicated at block 630. Upon receiving the request, the user is presented with a user-validation query, e.g., utilizing user-validation query component 236. This is indicated at block 640. As indicated at block 660, if the user is able to satisfy the user-validation query, i.e., the user is most likely a human user, then a survey is provided and the results are submitted to an interested entity, e.g., publisher, as indicated at block 670. Further, user indicia of a human user are returned as depicted at block 675. But if the user-validation is not satisfied, then the presentation of the survey is suppressed, and the failed status of the IP address is passed on as user indicia of a robotic user, as indicated at blocks 680 and 685, respectively.

With reference to FIG. 7, a flow diagram is illustrated that shows a method 700 for training a scoring module and receiving a score therefrom, e.g., utilizing scoring module 226, in accordance with an embodiment of the present invention. As indicated at block 710, the determination of probability is received, typically from the probability determining module 224. Also, in some embodiments, the historic behavior related to an IP address is received. This is indicated at block 720. The step of training the scoring module, e.g., scoring module 226, is indicated at blocks 740 and 750 where the scoring module 226 is updated based on comparing the information received, discussed above, and information presently stored therein, then consequently storing the updated scoring module 226. In addition, the scoring module (e.g., scoring module 226) provides a score associated with the IP address, or requesting user, as indicated at block 760. It is contemplated by the present invention that, upon training the scoring module, the determined probability that the request originated from a robotic user is passed on at this step concomitantly with, or in place of, the score.

As shown in FIG. 8, a flow diagram is illustrated that shows a method 800 for providing and adjusting a rate of delivery for presentation, e.g., utilizing advertisement selection module 228 of FIG. 2, in accordance with an embodiment of the present invention. Initially, as indicated at block 810, a score associated with an IP address is received, typically, e.g., from scoring module 226. This score is compared against a threshold value based upon known robotic traffic patterns (block 820), wherein a rate of presentation is adjusted in light of the comparison (block 830). Next, the comparison is used to determine whether to deliver for presentation a warning of robotic user, e.g., virus cleaner advertisement at FIGS. 13-15, based on the comparison, as is indicated at block 840.

FIG. 9 is a flow diagram that illustrates a method 900 for presenting an advertisement or an antivirus warning e.g., utilizing advertisement delivery module 230 of FIG. 2, in accordance with an embodiment of the present invention. As indicated at blocks 910 and 920, respectively, upon receiving the rate of presentation and the score, the likelihood that a robotic user made the request is determined. For instance, if it is determined that the requesting user is likely a robotic user, then presentation of advertisements is largely suppressed with the exception of virus cleaner advertisements as discussed above. This is indicated at block 930. But if it is determined that the requesting user is likely not a robotic user, then one or more advertisements to deliver for presentation (e.g., advertisements from advertisers, trap advertisements from publishers, feedback advertisements from publishers, and the like) are determined based upon the rate of presentation, and consequently presented at a user interface. This is indicated at blocks 950 and 960, respectively.

Turning now to FIG. 10, an illustrative screen display of a web page 1010 is illustrated that shows an exemplary user interface for displaying advertisements 1020 that include trap advertisements, 1012, 1018, in accordance with an embodiment of the present invention. In one embodiment, the web page 1010 is generated from a search query 1022, wherein the advertisements 1020 are relevant thereto. In addition, the advertisements 1020 may be selected based on the rate of presentation and presented by utilizing an advertisement delivery engine, e.g., advertisement delivery engine 210 of FIG. 2. As depicted on the web page 1010, an unapparent advertisement 1018 and an image advertisement 1012 are presented. In the illustrated embodiment, the unapparent advertisement 1018 is presented on the user interface display in such a way that it is invisible to a human user. Accordingly, any request associated with the unapparent advertisement 1018 is returned as user indicia of a robotic user. The image advertisement 1012 includes a call-to-action 1016 and a typical robotic user position of request 1014 on the user interface. The coordinates of the call-to-action 1016, e.g., “click here” location, are typically known and stored as the expected coordinates. The coordinates of the position of request 1014 are measured and compared to the expected coordinates, and as shown, in contrast thereto. As such, this embodiment depicts a position of request 1014 that is likely the result of a request from a robotic user.

Referring to FIG. 11, an illustrative screen display 1100 of an exemplary user interface for displaying a feedback advertisement prompt is shown, in accordance with an embodiment of the present invention. This advertisement may be delivered for presentation, for instance, by the advertisement delivery module 230 of FIG. 2, upon indication from the another module, e.g., score from scoring module 226 or a rate of presentation from advertisement selection module 228, that the user is a human user. However, presentation may occur randomly or by an algorithm implicit within the web page architecture. Upon acquiescing to participate in the survey, the user is provided with a user-validation query (not shown) to ensure a human user is supplying the feedback. Although the illustrative screen display 1100 is shown, it will be appreciated and understood by those of ordinary skill in the art that other embodiments of entering into an online survey exist. Some of these embodiments include presenting an advertisement with a corresponding icon on a web page that triggers a survey for that advertisement, or simply triggering the survey upon submitting a request associated with an advertisement, e.g., clicking on the advertisement.

Turning to FIG. 12, an illustrative screen display 135 of an exemplary user interface for displaying a survey portion of the feedback advertisement prompt is shown, in accordance with an embodiment of the present invention. The advantage of a survey is that user feedback may be accessed and utilized to continuously monitor the quality of the advertisements and the publishers that present those advertisements. As suggested above, the survey may provide information relating to one or more of the following: relevance of the advertisement, relevance and quality of the publisher, and relevance of the advertisement in view of the publisher and content presented therewith. The survey questions 1210 are designed to ascertain this information by prompting the user to respond in response areas 1212 by any rating system known to those of ordinary skill in the art. In the embodiment shown, a free-text field 1214 is provided for unstructured user feedback. The free-text field 1214 not only provides user feedback, but also may be used as user-verification test, in addition to the user-verification query, as free text is typically hard to forge by a robotic user.

Referring to FIG. 13, an illustrative screen display 1300 of an exemplary user interface for displaying an antivirus warning is shown, in accordance with an embodiment of the present invention. This advertisement/antivirus warning, and the exemplary advertisements/antivirus warnings shown in FIGS. 14 and 15, is typically delivered for presentation, for instance, by the advertisement delivery module 230 upon indication that the request originated from a robotic user even though the IP address has historically been considered belonging to a human user. As such, the advantage is that a human user is informed that their device is comprised by a robotic user (e.g., Botnet herders, adware, spyware, clicker Trojans, or other robots that generate click-streams), and offered services (e.g., virus cleaner software), so as to clean and repair their device. In this instance, the illustrative screen display 1300 suggests that the user update their current antivirus defense software by visiting the web site 1310 associated with the software provider.

An illustrative screen display 1400, similar to the an exemplary user interface 1300 of FIG. 13 is shown in FIG. 14, that presents the antivirus warning as an advertisement, in accordance with an embodiment of the present invention. As shown, the advertisement directs the user to a web page 1412 where assistance is available. In this embodiment, there is no link to the web page 1412, e.g., non-clickable, in order to traverse the possibility that a robotic user may have replaced the legitimate antivirus advertisement with its own malicious advertisement and link. In addition to the warning and advertisement, the type of robotic user is identified, as indicated at 1410.

Turning now to FIG. 15 is an illustrative screen display 1500 similar to the exemplary user interface 1400 of FIG. 14, but further displaying the a link 1510 to the advertiser's web page is shown, in accordance with an embodiment of the present invention. If it is determined that the robotic user, e.g., spyware program, will not co-opt the advertisement as suggested above, the clickable link 1510 to the advertiser's web page may be provided such that the user being provided with the illustrative screen display 1500 is easily directed to assistance.

The illustrated screen displays 1300 (FIG. 13), 1400 (FIG. 14), and 1500 (FIG. 15) provide a number of advantages. For instance, they provide genuine service to users by informing them of the nature of their infection, help to introduce users to antivirus software, and allow the web page publisher to respond to invalid click sources (e.g., robotic users) and shut them down.

As can be seen, embodiments of the present invention relate to computerized methods and systems for selecting one or more advertisements for presentation based upon at least one request for a web page submitted by a user. In embodiments, the web page request may be received in association with the presentation of a trap advertisement (e.g., an unapparent advertisement or an image advertisement) or in association with the presentation of a feedback advertisement designed to solicit advertisement and/or publisher feedback from human users. The nature of the request is utilized to determine a probability that the requesting user is robotic as opposed to human. This determined probability, along with historic behavior related to the requesting user, is used to provide a score that is subsequently utilized in selecting one or more advertisements for presentation to the user. In one embodiment, if the score overcomes a threshold pre-defined based on robotic traffic patterns, a virus cleaner advertisement is presented to warn a potential human user of suspected infection and/or provide a mechanism for cleaning their system of viruses. In another embodiment, the score is utilized to adjust the rate at which commercial advertisements, as opposed to trap advertisements, are presented, thereby optimizing web page publisher revenue and reducing inappropriate billing for invalid requests.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for identifying automated click fraud programs, the method comprising:
presenting an advertisement to a user, the user being associated with an identifier;
measuring at least one user behavior related to the presented advertisement;
utilizing the measured at least one user behavior to determine a probability that the user is robotic; and
storing the probability and the associated at least one user behavior in association with the user identifier.

2. The one or more computer-readable media of claim 1, wherein utilizing the measured at least one user behavior to determine a probability that the user is robotic comprises comparing the measured at least one user behavior to a pre-defined behavior standard known to be associated with robotic users, and utilizing the comparison to determine the probability that the user is robotic.

3. The one or more computer-readable media of claim 1, further comprising:
analyzing historic behavior associated with the user;
assigning a score to the user based upon the analyzed historic behavior and the determined probability;
storing the score in association with the user identifier.

4. The one or more computer-readable media of claim 3, further comprising utilizing the stored probability, associated at least one user behavior and assigned score to train a scoring mechanism, wherein the scoring mechanism is configured to assign scores to a plurality of users.

5. The one or more computer-readable media of claim 3, further comprising selecting at least one advertisement for presentation based upon the assigned score.

6. The one or more computer-readable media of claim 1, wherein presenting the advertisement to the user comprises presenting an advertisement associated with call-to-action identifier.

7. The one or more computer-readable media of claim 6, further comprising:
receiving a response to the call-to-action identifier;
presenting a validation mechanism; and
determining if the validation mechanism is successfully completed, wherein if it is determined that the validation mechanism is successfully completed, the probability that the user is robotic is determined to be low.

8. The one or more computer-readable media of claim 7, wherein presenting the validation mechanism comprises presenting at least one of a Turing test and a passport login.

9. The one or more computer-readable media of claim 7, wherein if it is determined that the validation mechanism is successfully completed, the method further comprises:
presenting a user-feedback survey; and
determining if feedback is received in association with presentation of the user-feedback survey, wherein if it is determined that feedback is received, the probability that the user is robotic is decreased.

10. The one or more computer-readable media of claim 9, wherein the method further comprises utilizing the received feedback to determine one or more of relevance of the advertisement, quality of a publisher associated with the advertisement, relevance of a publisher associated with a web page on which the advertisement is presented, relevance of the advertisement to the web page associated with the publisher, and whether the web page associated with the publisher is legitimate.

11. The one or more computer-readable media of claim 6, wherein presenting the advertisement associated with the call-to-action identifier comprises presenting the advertisement with an invitation to select an identifier at designated coordinates, wherein measuring the at least one user behavior related to the presented advertisement comprises measuring a distance between the designated coordinates and coordinates selected by the user, and wherein the closer the measured distance is from the designated coordinates, the lower the probability that the user is robotic.

12. The one or more computer-readable media of claim 6, wherein presenting the advertisement associated with the call-to-action identifier comprises presenting an unapparent advertisement, wherein the method further comprises determining whether user action is taken with respect to the unapparent advertisement, and wherein if it is determined that user action is taken with respect to the unapparent advertisement, the probability that user is robotic is increased.

13. The one or more computer-readable media of claim 3, wherein if upon analyzing the historic behavior associated with the user it is determined that the probability that the user is robotic is high, the method comprises one of selecting a virus cleaner advertisement for presentation and at least partially suppressing advertisement presentation.

14. The one or more computer-readable media of claim 3, further comprising altering the rate of advertisement presentation based upon one or more of the probability that the user is robotic and the score assigned to the user.

15. A computer system for selecting advertisements for identifying automated click fraud programs, the system comprising:
a probability determining module configured to determine a probability that a user submitting a request for a web page is a robotic user based upon at least one measured user behavior;
a scoring module configured to analyze at least one of the probability that the user submitting the request for the web page is a robotic user and historic user behavior and to assign a score to the user;
an advertisement selection module configured to utilize the assigned user score to select one or more advertisements for presentation; and
an historic user behavior database configured to store one or more of the determined probability, the at least one measured user behavior, the assigned score and the one or more selected advertisements in association therewith.

16. The computer system of claim 15, further comprising an advertisement delivery module configured to deliver at one or more selected advertisements to a user device for presentation in association therewith.

17. The computer system of claim 16, further comprising an advertisement database configured to store one or more of an unapparent advertisement, an image advertisement, a user feedback advertisement, and a virus warning advertisement.

18. A computerized method for selecting one or more advertisements for presentation that are designed to warn a user of a potential virus, the method comprising:
incident to receiving at least one user request for a web page, determining a probability that the at least one request originated from a robotic user; and
utilizing the determined probability to assist in selecting the one or more advertisements to present, wherein if the determined probability is high, the one or more selected advertisements include at least one virus warning.

19. The computerized method of claim 18, further comprising presenting the one or more selected advertisements.

20. The computerized method of claim 19, wherein presenting the one or more selected advertisements comprises presenting instruction for removal of the potential virus.
